(19) United States
(12) Patent Application Publication
(10) Pub. No.: US 2012/0130015 A1
(43) Pub. Date: May 24, 2012

(54) PRODUCTION OF MOULDED BODIES CONTAINING ADDITIVES

(75) Inventors: Klaus Horn, Dormagen (DE); Olaf Zoellner, Leverkusen (DE); Gianmaria Malvestiti, Brembate (IT); Andrea Scagnelli, Bonate Sotto (IT); Massimo Tironi, Treviolo (IT)

(73) Assignee: Bayer MaterialScience AG, Leverkusen (DE)

(21) Appl. No.: 13/388,077

(22) PCT Filed: Jul. 31, 2010
(86) PCT No.: PCT/EP10/04696

§ 371 Date: Jan. 31, 2012

(30) Foreign Application Priority Data
Aug. 3, 2009 (IT) RM2009A000418
Aug. 3, 2009 (IT) RM2009A000419

(51) Int. Cl. C08L 69/00; B28B 1/093; B29C 45/17

(52) U.S. Cl. 524/611; 264/328.18; 264/69

(57) ABSTRACT

The present invention relates to a method for the accelerated production of thermoplastic molded bodies containing additives in reproducible quality, particularly for the accelerated production of dyed thermoplastic molded bodies with high color consistency.

The present invention relates to a method for the accelerated production of additive-containing thermoplastic moulded bodies of reproducible quality, in particular for the accelerated production of coloured thermoplastic moulded bodies with high colour constancy.

The mixing of additives into thermoplastics is conventionally carried out by extrusion in a compounding extruder. In the most advantageous case, so-called masterbatches can also be added to the thermoplastic without additives, into which masterbatches the desired additives have previously been compounded in as high a concentration as possible. In both cases, the thermoplastic plastic must be completely or partially extruded in order to produce the compound before actually being processed to the moulded body, which on the one hand is time-consuming and expensive and on the other hand also means an additional thermal load on the thermoplastic, which can lead to degradation reactions. Precisely when thermoplastic plastic/additive mixtures with many different concentrations are to be produced, the many individual production and cleaning steps that are required can mount up considerably. This is true in particular for the colour setting of additive/thermoplastic mixtures, where many different colour sample sheets of high and reproducible quality must be produced.

There has therefore been no lack of attempts to optimise the process of mixing additives into thermoplastics.

In order to be able to produce composites that are as uniform as possible, US 2008/0197523 A1 proposes a continuous production method using a specific metering system in combination with a preheater and an extruder. Although the processing of the premixtures in an injection moulding machine is also mentioned, it is not possible to produce homogeneous composite plastics/additives mixtures of satisfactory quality on a standard injection moulding machine by this method.

DE 197 10 610 A1 discloses an injection moulding process for the production of pigmented or filler-containing moulded bodies from mixtures of polymers and pigments and/or fillers using a modified injection moulding machine, wherein, prior to injection moulding, the starting materials of the mixture are mixed with one another outside the injection moulding machine in mechanical mixers or in containers on cylinder mills and this mixture is then melted and processed in the injection moulding machine. An injection moulding machine having a special degassing screw with a shearing web is used, and the mixture is homogenised by means of mixing elements arranged downstream of the screw. A disadvantage of this process is that the polymers and additives are statically charged as a result of the mechanical mixing and residues of additives remain on the walls of the mixing vessels. These residual amounts are missing from the moulded parts produced and distort the result, especially in the case of colour matching. The melt is also additionally loaded by the necessary use of a shearing web. Furthermore, this process requires a high outlay for the subsequent cleaning of the mixing vessels.

DE 44 43 153 A1 discloses a process for the production of mouldings or moulded bodies from mixtures of polymers with the aid of the injection moulding process, in which the starting materials of the mixture are mixed intensively with one another outside the injection moulding machine prior to injection moulding and the mixture is then melted and processed in the injection moulding machine, wherein the mixture consists of at least two or more polymers, at least one of which is thermoplastic, the starting materials of the mixture are mixed with one another in powder form, prior to the injection moulding, at a temperature below the melting point of the polymer component having the lowest melting point, and the mouldings or moulded bodies produced are in particular light in colour or colourless. The preparation of the mixtures is carried out in mechanical mixtures conventional per se. In order to prevent the components of the mixtures from separating before the injection moulding, the mixtures must, however, be constantly circulated in the hopper of the injection moulding machine by stirring or shaped after mixing into granulate-like, for example lenticular, pressed articles. The additional use of particular mixing and shearing devices is recommended. In this process, the substances used must be intensively mechanically mixed beforehand, with the same disadvantages as in DE 197 10 610 A1. In addition, separation of the mixtures must be prevented in a complex manner by constant stirring in the hopper of the injection moulding machine or even by the complex production of lenticular pressed articles.

In the novel method according to the invention, it is also possible to use plastics granulates, grinding is no longer necessary. Nevertheless, it is also suitable in particular for the production of coloured plastics and yields qualities with which colour sample sheets can be produced.

WO 00/73752 A1 describes a process for colouring or compounding thermoplastics or thermosets directly during an injection moulding or blow moulding process. In the process, the intrinsic colour of the polymer to be coloured is first measured and compared with a sample of the colour to be obtained, in order to determine the exact qualitative and quantitative composition of the required colouring agents. In the second step, the required colouring agents and optionally additives are then weighed in and mixed with a rotary mixer. In a third working step, this mixture is transferred to a suitable metering device and fed in defined amounts to a stream of thermoplastics and/or thermosets. In the fourth and last working step, injection moulding or blow moulding of the material takes place. This process is characterised by four working steps, which require a high outlay in terms of time and coordination. Also, the amounts of additives metered in fluctuate constantly within certain tolerances when metering devices are used, so that, for example in the addition of colouring agents, colour constancy from one moulding to the next is not ensured.

WO 03/018287 A2 discloses processes and devices for the rapid production of homogeneous mixtures from multi-component systems, for example plastics mixtures, and for the production and testing of moulded bodies thereof. A device for producing moulded bodies is likewise disclosed. In the process, a primary stream of a component is first produced in the first mixing step, to which further components are then added via one or more secondary streams and thus combined to form a premixture stream. The premixture stream is then conveyed further through a mixing device having a radial mixing action. It is a disadvantage of this process too that the components are fed through various streams, so that certain metering fluctuations occur which, for example in the production of defined coloured moulded bodies, lead to deviations in the colorimetric measured values of the mouldings from one another. The disclosed process is additionally technically complex.

Mixers which work according to the so-called resonance-vibration principle have been known for some time. U.S. Pat. No. 7,188,993 B1 and WO 2008/088321 A1 describe an apparatus and a process for mixing according to that process. In the product brochure, the mixing of polyethylene granulates with carbon black powder is described. In WO-A 99/65656, open-pore porous polymers are filled with very finely divided solids and then optionally coated with liquids. However, plastics, in particular those used within the context of the present invention, do not usually exhibit such porosity. Also, WO-A 99/65656 does not describe an injection moulding process. Accordingly, it is not apparent from the prior art that and how thermoplastic plastic/additive mixtures produced by mixers that work according to the resonance-vibration principle can be processed to moulded bodies in which the additives are distributed homogeneously.

Accordingly, the object underlying the invention is to provide a method with which additive-containing thermoplastic mouldings of very high quality and with high colour constancy can be produced simply and rapidly.

The object is achieved according to the invention by a method for producing additive-containing thermoplastic moulded bodies which comprises the following steps:
a.) preparation of a premixture containing as components at least one thermoplastic plastic and one or more additives;
b.) thermoplastic processing in an injection moulding machine containing static and/or dynamic mixing elements.

Surprisingly, it has been found that thermoplastic plastics moulded bodies which contain homogeneously distributed additives and satisfy the highest quality demands, such as are made, for example, in the case of colour setting and matching, can be produced by the method according to the invention.

Preferably, the preparation of the premixture is carried out with the aid of a mixer without mechanical mixing elements. Mechanical mixing elements are understood as being mixing rods, mixing propellers, kneading hooks or the like.

Prior compounding in order to homogenise the additives and colouring agents is not necessary in this method.

The mixers without mechanical mixing elements that are preferably used within the context of the present invention work according to the resonance-vibration principle. The mixture is made to resonate by an oscillator. The mixtures are produced with frequencies of >16 Hz and <1000 Hz. The corresponding apparatus and associated mixing methods are described in detail in U.S. Pat. No. 7,188,993 B1 and in WO 2008/088321 A1.

The mixtures are preferably produced with frequencies between 30 and 600 Hz, most particularly preferably between 40 and 200 Hz.

Mixers that work according to the resonance-vibration principle are commercially available in various forms under the name ResonantAcoustic® Mixer from Resodyn Acoustic Mixers Inc., 130N. Main St., Suite 630, Butte, Mont. 59701.

Suitable starting materials for the preparation of the premixture in step a.) are any thermoplastic polymers, for example polyamide (PA), polyesters, in particular polyethylene terephthalate (PET), polybutylene terephthalate (PBT), polyacrylates, in particular polymethyl methacrylate (PMMA), polystyrene (PS), syndiotactic polystyrene, acrylonitrile-butadiene-styrene (ABS), acrylic ester-styrene-acrylonitrile (ASA), polyolefin, in particular polypropylene (PP), polyethylene (PE), polycarbonate (PC), copolycarbonate (CoPC), copolyester carbonate, or a mixture of these plastics. In a preferred embodiment, the plastics are amorphous thermoplastic plastics, in particular polycarbonate, copolycarbonate, copolyester carbonate and polycarbonate mixtures consisting of polycarbonate and acrylonitrile-butadiene-styrene (ABS), acrylic ester-styrene-acrylonitrile (ASA), polybutylene terephthalate (PBT) and polyethylene terephthalate (PET).

The thermoplastic polymers are used in the form of granulates and/or powders. In the case of granulates, which are conventionally used, they can be granulates produced from a polymer strand (strand granulates) or granulates produced by underwater granulation (underwater granulates). The powders can be prepared by grinding the granulates or also by precipitation from polymer solutions.

The additives are used in the form of the commercially available solids powders, oils and/or pastes as well as in the form of liquids. For example, the following additives can be incorporated by this method: colouring agents, i.e. inorganic and organic colourings and pigments, demoulding agents, lubricants, flow agents, UV stabilisers, IR absorbers, flameproofing agents, optical brightening agents, inorganic and organic diffuser particles, antistatics, heat stabilisers, nucleating agents, fillers, glass beads, glass and carbon fibres, impact modifiers and carbon nanotubes. The colourings and pigments can be organic or inorganic, for example titanium dioxide, barium sulfate and zinc oxide. Carbon black and metal flakes are also used. Examples of polymeric diffuser particles are polyacrylates and PMMA, for example core-shell acrylates, polytetrafluoroethylenes, polyalkyltrialkoxysilanes and mixtures of these components. UV absorbers belong, for example, to the classes benzotriazoles, oxalanilides, 2-cyanoacrylates, benzilidine malonates and formamidines as well as benzophenones, in particular dibenzoylresorcinols, and triazines, in particular 2-(2-hydroxyphenyl)-1,3,5-triazine.

In principle, there are no limitations as regards the choice of additives which can be incorporated by this method. Further possible additives are described, for example, in WO 99/55772, p. 15-25, EP-A 1 308 084 and in the appropriate chapters of the “Plastics Additives Handbook”, ed. Hans Zweifel, 5th Edition 2000, Hanser Publishers, Munich.

The total amount of additives in the polymer is from 0.000001 wt. % to 50.000000 wt. %, preferably from 0.001 wt. % to 40.000 wt. %, particularly preferably from 0.01 wt. % to 30.00 wt. %. Accordingly, the amount of thermoplastic polymer in the composition is from 50.000000 wt. % to 99.999999 wt. %, preferably from 60.000 wt. % to 99.999 wt. %, particularly preferably from 70.00 wt. % to 99.99 wt. %.

The granulates within the scope of the invention are cylindrical to spherical granulates. Cylindrical granulates are from 0.5 mm to 10.0 mm, preferably from 1 mm to 5 mm and particularly preferably from 2 to 4 mm long and have a diameter of from 0.5 mm to 6.0 mm, preferably from 1 mm to 4 mm and particularly preferably from 2 to 3 mm. They have a 100-grain weight (defined as the average weight of 100 granule grains) of from 1.0 g to 4.0 g.

Spherical granulates have a diameter of from 0.5 mm to 6.0 mm, preferably from 1 mm to 4 mm and particularly preferably from 2 to 3 mm, and a 100-grain weight of from 1.0 g to 4.0 g.

Powders of the thermoplastic polymers within the scope of the invention consist of particles of irregular geometry. The particle sizes are in the range from 0.01 mm to 5.00 mm, preferably from 0.1 mm to 2.0 mm.

The particle size distribution can be monomodal to multimodal; monomodal and bimodal distributions are preferred.

Powders of the additives and colouring agents within the scope of the invention consist of particles of irregular geometry. The particle sizes are in the range from 0.01 mm to 2.00 mm, preferably from 0.01 mm to 1.00 mm and most particularly preferably from 0.01 mm to 0.05 mm.

The particle size distribution can be monomodal to multimodal; monomodal and bimodal distributions are preferred.

Additives according to the invention are also nanotubes, preferably carbon nanotubes (CNTs).

The mixtures of thermoplastic polymers and additives prepared according to the resonance-vibration principle are characterised in that the additives applied to the surfaces of the granulates or the ground granulate particles adhere firmly, so that a virtually dust-free mixture is achieved. The mixtures so prepared can therefore be removed cleanly from the mixing vessel without residues of additives remaining in the mixing vessel. It is thus ensured that the premixture can be processed to thermoplastic moulded bodies which contain the desired concentration of additives, pigments and colourings and the mixing vessel does not have to be cleaned in order to be able to prepare further mixtures which comply with the specifications.

Injection moulding machines with dynamic or static mixing elements are used to produce the thermoplastic moulded bodies from the premixtures according to the invention.

An example of a dynamic mixer is the Twente Mixing Ring (TMR), which is screwed onto the screw in place of a standard non-return valve. The short variants with an enlargement of the angle of the sealing surface from 30° to 90° are particularly preferred.

The static mixers consist of a plurality of free-standing mixing elements of the same type, which are incorporated into the melt flow channel, preferably into the nozzle of the plastification unit, with the individual elements offset by defined angles. The individual mixing elements consist of guide plates or guide webs, spiral guides or bore bundles which divide the flowing medium (melt) into partial streams whose radial positions in the flow channel, and positions relative to one another, change constantly and accordingly lead to homogenisation of the individual components. A preferred variant of a static mixer is produced by precision casting. As a result of the optimised geometry, shorter residence times, no dead spots and an improved mixing action are achieved. Also suitable are static mixers in which the melt is guided through two or more helical channels which come together again at the end.

Static mixers are available commercially, for example, from Sulzer-Chemtech (P.O. Box 65 CH-8404 Winterthur, Switzerland) or Fluitec (Seuzachstrasse 38, CH-8413 Neftenbach, Switzerland).

Accordingly, the invention provides a method for the accelerated production of additive-containing thermoplastic moulded bodies, which method is a combination of a special mixing process, which uses the resonance-vibration principle, with a modified injection moulding process, in which a dynamic and/or static mixer is arranged downstream of the injection moulding screw. The method according to the invention permits the production of additive-containing, in particular coloured, moulded bodies of high and reproducible, homogeneous quality, without prior homogenisation of the polymers with the additives in an extruder in the melt and subsequent granulation having to be carried out and the granulates resulting therefrom only then being able to be subjected to an injection moulding process for the production of thermoplastic moulded bodies.

With the aid of the method comprising steps a.) and b.), the required outlay and the required time for the production of additive-containing moulded bodies can be reduced by at least 25% as compared with the standard process.

The method is characterised in that the standard deviation of the colorimetric data of the colour sample sheets from one another is <0.1%.

The acoustic mixer can likewise be used in an advantageous manner in a method for the production of additive-containing thermoplastic moulded bodies, which comprises the following steps:
i.) preparation of a premixture containing as components at least one thermoplastic plastic and one or more additives;
ii.) thermoplastic processing of the premixture in a single-shaft or twin-shaft extruder.

This method is suitable in particular for additives which can otherwise be incorporated only with difficulty by the extrusion process. That is to say, by means of this method comprising steps i) and ii) it is possible to produce from thermoplastic plastics and additives thermoplastic extrudates (strands, granulates, sheets, foils, hoses, profiles or extruded blow mouldings) which are particularly homogeneous.

### EXAMPLES

The present invention is to be explained in greater detail by means of the examples. The mixtures of a polycarbonate and colouring pigments as described in Tab. 1 were used for this purpose.

The polycarbonate in all cases was Makrolon® 3108, a bisphenol A-based polycarbonate without additives having a melt volume flow rate (MVR) according to ISO 1133 of 6.0 cm³/(10 min), measured at 300° C. and a 1.2 kg load.

The mixtures were then processed to colour sample sheets both by the method according to the invention (A) and by alternative industrial methods (B-D) and then tested in respect of their colour quality (see Table 2).

### Description of the Methods:

### A) Technology According to the Invention:

### Preparation of the Polymer/Colouring Agent Mixtures:

Before the mixtures are prepared, the polycarbonate powder or granulate is dried for 4 hours at 120° C. in a dry-air dryer and then mixed together with the colouring agents for 3 minutes at a frequency of 40 to 60 Hz in a closable vessel by means of a LabRAM Resonant Acoustic®Mixer, the acoustic mixer automatically setting the optimum frequency at which resonance occurs.

Total batch size: size of the individual batch in method A: in each case 500 g

### Production of the Colour Sample Sheets:

The colour sample sheets are produced by the injection moulding process on an Arburg 370S 800-150. The machine is equipped with a combination of static mixers from Sulzer of type SMK-X DN 12 (with 6 elements) and SMK-X DN 12 (with 2 elements). The closing force of the machine is 800 kN. The screw diameter is 25 mm. The sheets are produced at a melt temperature of 300° C. and a tool temperature of 90° C. The polymer/colouring agent mixture is introduced into the feed hopper, melted in the screw and processed to colour sample sheets (75×50×4 mm). The colour sample sheets are then subjected to colorimetry.

### B) Standard Technology

Prior to the preparation of the mixtures, the polycarbonate granulate and the polycarbonate powder are each dried for 4 hours at 120° C. in a dry-air dryer. The polycarbonate powder is then mixed together with the colouring agents for 3 minutes in a Mixako—container mixer LAB CM 3-12 CC/MB. The polycarbonate powder/colouring mixture and the polycarbonate granulates are metered into a twin-shaft extruder (ZSK 25) from Coperion, each via a scale and each by means of a hopper, melted at 300° C. and extruded. The polymer strands are then cut into granulate grains by means of an extrusion granulator.

Size of the individual batch in method B (extruder method, standard technology): in each case 5 kg

The granulate grains are dried for 4 hours at 120° C. in a dry-air dryer. The granulate grains are then melted at 300° C. in a conventional injection moulding machine (Arburg 370S 800-150) and processed to colour sample sheets (75×50×4 mm). The colour sample sheets are then subjected to colorimetry.

Total batch size: 5 kg

C) Method with Static Mixing Elements in the Injection Moulding Machine Using a Tumbling Mixer (Not an Acoustic Mixer)

Prior to the preparation of the mixtures, the polycarbonate powder (granulates) is dried for 4 hours at 120° C. in a dry-air dryer and then mixed together with the colouring agents for 3 minutes in a LBB Bohle LM 40 tumbling mixer.

Size of the individual batch in method C: in each case 500 g

The colour sample sheets are produced by the injection moulding process on an Arburg 370S 800-150. The machine is equipped with a combination of static mixers from Sulzer of type SMK-X DN 12 (with 6 elements) and SMK-X DN 12 (with 2 elements). The closing force of the machine is 800 kN. The screw diameter is 25 mm. The sheets are produced at a melt temperature of 300° C. and a tool temperature of 90° C. The mixture is introduced into the feed hopper, melted and processed to colour sample sheets (75×50×4 mm). The colour sample sheets are then subjected to colorimetry.

Total batch size: 500 g

D) Without Method without Acoustic Mixer and without Static Mixing Elements in an Injection Moulding Machine

Prior to the preparation of the mixtures, the polycarbonate granulate and the polycarbonate powder are dried for 4 hours at 120° C. in a dry-air dryer. The polycarbonate powder (granulate) is then mixed together with the colouring agents for 3 minutes in an LBB Bohle LM 40 tumbling mixer.

Size of the individual batch in method D: in each case 500 g

The mixtures are then melted at 300° C. in a conventional injection moulding machine (Arburg 370S 800-150) and processed to colour sample sheets (75×50×4 mm). The colour sample sheets are then subjected to colorimetry.

Total batch size: 500 g

### E) Testing by Colorimetry:

The colorimetry was carried out on all the sheets by the same procedure according to standard DIN 6174 regardless of the method of producing the sheets.

Opaque colours are measured with 45/0° geometry and a measuring interval of 10 nm. A Color-Eye 2145 device from Gretag MacBeth was used to measure the opaque colours.

Transparent colours are measured with d/8° geometry with a measuring interval of 5 nm. An Ultrascan PRO device from HunterLab was used to measure the transparent colours.

TABLE 1
Compositions of the examples; *all amounts in wt. %

| | | | | Exam- | Exam- | Exam- | Exam- | Exam- | Exam- |
|---|---|---|---|---|---|---|---|---|---|
| Component of the | | | | ple | ple | ple | ple | ple | ple |
| colouring composition | Manufacturer | CAS No. | Colour index | 1* | 2* | 3* | 4* | 5* | 6* |
| Makrolon ® 3108 | Bayer | | — | 98.8988 | 98.8900 | 99.5280 | 99.1270 | 98.6686 | 99.7960 |
| | MaterialScience | | | | | | | | |
| | AG | | | | | | | | |
| Heucodur ® Yellow 6R | Heubach | 068186-90-3 | Pigment Brown 24 | — | — | 0.0540 | | | |
| Macrolex Violet 3R ® | Lanxess AG | 0000082-16-6 | Solvent Violet 36 | — | — | 0.0040 | | | |
| Carbon Black ® 4350 | Cabot Corp. | 001333-86-4 | Pigment Black 7 | — | — | 0.0340 | | | |
| Titanium Kronos ® 2230 | Kronos Titan AG | 013463-67-7 | Pigment White 6 | 1.0500 | 0.9000 | 0.380 | 0.5300 | 0.9600 | |
| Sicotan Yellow ® K1010 | BASF AG | 008007-18-9 | Pigment Yellow 53 | 0.0450 | 0.1730 | — | | | |
| Colortherm ® Red 130M | Lanxess AG | 001309-37-1 | Pigment Red 101 | 0.0020 | 0.0120 | — | | 0.0140 | |
| Lamp Black ® 101 | Degussa AG | 77266 | Pigment Black 7 | 0.0042 | 0.0250 | — | | | |
| Sicotan ® Yellow K2107 | BASF AG | 068186-90-3 | Pigment Brown 24 | — | — | — | | 0.3300 | |
| Colortherm ® Yellow 30 | Bayer AG | 68187-51-9 | Pigment Yellow 119 | — | — | — | | 0.0230 | |
| Elftex ® 570 pearls | Cabot | 001333-86-4 | Pigment Black 7 | — | — | — | | 0.0044 | |
| Sicotan ® Yellow K1010 | BASF AG | 008007-18-9 | Pigment Yellow 53 | — | — | — | 0.0330 | | |
| Ultramarine Blue Premier | Holiday Pigments | 057455-37-5 | Pigment Blue 29 | — | — | — | 0.3000 | | |
| FRX ® | | | | | | | | | |
| Pemcolor ® Green 405 | Pemco Emails | 068186-85-6 | Pigment Green 50 | — | — | — | 0.0100 | | |
| Macrolex ® Yellow 3G | Lanxess AG | 004174-09-8 | Solvent Yellow 93 | — | — | — | | | 0.2000 |
| Heliogen Blue ® K 6911 D | BASF AG | 000147-14-8 | Pigment Blue 15:1 | — | — | — | | | 0.0040 |

TABLE 2
Production of the colour sample sheets and assessement of the colour quality:

| Colour | | | | | | | | | | |
|---|---|---|---|---|---|---|---|---|---|---|
| sample | Colour | | Production | | | | | | | |
| sheets | recipe | Colour impression | process | Cielab colour system | | | Standard deviation | | | |
| Example | Example | after testing E | acc. to. | L* | a* | b* | σL* | σa* | σb* | Observations |
| 7 | 1 | RAL 7035—Opaque light grey | A | 81.00 | −1.15 | 1.99 | 0.02 | 0.02 | 0.03 | |
| 8 | 1 | RAL 7035—Opaque light grey | B | 80.65 | −1.28 | 2.45 | 0.06 | 0.02 | 0.06 | |
| 9 | 1 | RAL 7035—Opaque light grey | D | 80.85 | −1.27 | 2.33 | 0.15 | 0.08 | 0.21 | Streaks of colour on the surface |
| 10 | 1 | RAL 7035—Opaque light grey | C | 81.59 | −0.75 | 2.44 | 0.11 | 0.03 | 0.05 | |
| 11 | 2 | RAL 7045—Opaque mid-grey | A | 61.92 | −0.90 | 0.75 | 0.02 | 0.03 | 0.06 | |
| 12 | 2 | RAL 7045—Opaque mid-grey | D | 60.68 | −1.02 | 1.09 | 0.44 | 0.16 | 0.58 | Streaks of colour on the surface |
| 13 | 2 | RAL 7045—Opaque mid-grey | C | 61.42 | −0.87 | 0.55 | 0.26 | 0.03 | 0.08 | Streaks of colour on the surface |
| 14 | 3 | RAL 7015—Opaque dark grey | A | 29.46 | −0.31 | −2.56 | 0.09 | 0.02 | 0.02 | |
| 15 | 3 | RAL 7015—Opaque dark grey | B | 26.62 | −0.41 | −2.62 | 0.05 | 0.02 | 0.02 | |
| 16 | 3 | RAL 7015—Opaque dark grey | C | 29.38 | −0.29 | −1.8 | 1.09 | 0.05 | 0.37 | |
| 17 | 4 | RAL 5024—Opaque blue | A | 49.76 | −6.87 | −20.59 | 0.06 | 0.02 | 0.09 | |
| 18 | 4 | RAL 5024—Opaque blue | C | 57.43 | −6.71 | −36.57 | 0.53 | 0.24 | 0.57 | |
| 19 | 4 | RAL 5024—Opaque blue | B | 49.39 | −7.09 | −19.44 | 0.01 | 0.02 | 0.03 | |
| 20 | 5 | RAL 1019—Opaque yellow | A | 64.89 | 3.87 | 19.48 | 0.06 | 0.02 | 0.04 | |
| 21 | 5 | RAL 1019—Opaque yellow | C | 65.65 | 4.85 | 21.7 | 1.51 | 0.84 | 1.56 | |
| 22 | 5 | RAL 1019—Opaque yellow | B | 68.34 | 3.69 | 16.8 | 0.02 | 0.03 | 0.04 | |
| 23 | 6 | Transparent green | B | 78.87 | −33.00 | 109.34 | 0.23 | 0.17 | 0.17 | |
| 24 | 6 | Transparent green | A | 79.29 | −35.15 | 108.75 | 0.04 | 0.07 | 0.09 | |
| 25 | 6 | Transparent green | C | 79.05 | −35.24 | 108.79 | 0.06 | 0.12 | 0.08 | |

### Interpretation of the Test Results:

With the technology according to the invention (combination of acoustic mixer and static mixing elements in the injection moulding machine), the same results in colour setting can be achieved as with the conventional procedure (production of granulate in a twin-shaft extruder with subsequent production of the sheets using an injection moulding machine), but with a considerably reduced outlay in terms of time. Without the use of an acoustic mixer, colour sample sheets with very divergent colorimetric values, in some cases even with marked inhomogeneities in the form of streaks of colour, are obtained.

Time saving (see Table 3):

With the method according to the invention, the production of corresponding colour sample sheets and the development of new recipes which have a defined new colour aim can be accelerated considerably. With method A, only 500 g are required, but 5 kg are required in method B. A marked saving in terms of material can accordingly be made with method A.

TABLE 3
Outlay in terms of time for methods A (technology according to the
invention) and B (standard technology)

| | Method A | Method B |
|---|---|---|
| Method steps | [minutes] | [minutes] |
| Drying | 240 | 240 |
| Cleaning injection moulding machine | 15 | n.a. |
| Cleaning extruder | n.a.* | 60 |
| Cleaning mixer | n.a.* | 30 |
| Preparing mixture | 15 | 25 |
| Extrusion | n.a.* | 30 |
| Drying granulates | n.a.* | 240 |
| Producing colour sample sheets | 15 | 15 |
| | 285 | 640 |

*n.a. = not applicable

1.-12. (canceled)

13. A method for producing additive-containing thermoplastic moulded bodies, comprising the steps of
a) preparing a premixture comprising as components at least one thermoplastic plastic and one or more additives,
b) thermoplasticly processing the premixture in an injection moulding machine containing static and/or dynamic mixing elements.

14. The method according to claim 13, wherein the premixture is prepared according to the resonance-vibration mixing principle.

15. The method according to claim 14, wherein the premixture is prepared with frequencies of from 16 to 1000 Hz.

16. The method according to claim 13, wherein at least one of the one or more additives comprises a colouring agent.

17. The method according to claim 13, wherein the thermoplastic plastic is present in one of the following forms:
a. cylindrical granulate having a length of from 0.5 to 10 mm and a diameter of from 0.5 mm to 6 mm and a 100-grain weight of from 1 to 4 g;
b. spherical granulate having a diameter of from 0.5 mm to 6 mm and a 100-grain weight of from 1 g to 4 g;
c. powder having a mean particle size of from 0.01 mm to 5 mm and a monomodal or bimodal particle size distribution.

18. The method according to claim 13, wherein the at least one of the one or more additives is in the form of a powder having particle sizes of from 0.01 mm to 2 mm and a monomodal or bimodal particle size distribution.

19. The method according to claim 13, wherein the premixture prepared in step a) is virtually dust-free.

20. A method for producing homogeneous extrudates comprising preparing a premixutre comprising as components at least one thermoplastic plastic and one or more additives, and processing the premixture in single-shaft or twin-shaft extruder.

21. The method according to claim 20, wherein the extrudates are selected from the group consisting of strands, granulates, sheets, foils, hoses, profiles and extrusion blow mouldings.

22. The method according to claim 13, wherein the thermoplastic moulded bodies are colour sample sheets in the colour setting or matching of additive/thermoplastic mixtures.

23. Virtually dust-free thermoplastic polymer granulates having on their surface one or more firmly adhering additives, produced according to the resonance-vibration principle at frequencies of from 16 Hz to 1000 Hz.

24. Virtually dust-free thermoplastic polymer granulates according to claim 23, wherein the thermoplastic polymer comprises polycarbonate and at least one of the one or more additives comprises a colouring agent.
